(19) United States
(12) Patent Application Publication
(10) Pub. No.: US 2006/0070490 A1
(43) Pub. Date: Apr. 6, 2006

(54) Composite transmission housing and method of making same

(75) Inventor: Curtis G. Richardson, Herrin, IL (US)

Correspondence Address: MCKEE, VOORHEES & SEASE, P.L.C.;ATTN: MAYTAG, 801 GRAND AVENUE, SUITE 3200, DES MOINES, IA, 50309-2721, US

(73) Assignee: Maytag Corporation, Newton, IA (US)

(21) Appl. No.: 10/957,157

(22) Filed: Oct. 1, 2004

(51) Int. Cl. F16H 57/02

(52) U.S. Cl. 74/606 R

(57) ABSTRACT

A composite transmission housing is provided with a die-cast metal base and an over-molded plastic body. The metal base provides mechanical strength for the transmission gears, while the plastic body forms a leak-free oil pan for the transmission oil. The method of making the composite transmission housing includes the steps of die-casting the metal base, inserting the base into a mold, and over-molding the plastic body onto the base.

### BACKGROUND OF THE INVENTION

Transmission housings, particularly for appliances such as washing machines, typically are formed of metal using a die-cast process. The die-cast metal housing provides mechanical strength to support the plurality of transmission gears within the housing. However, the tooling used in the die-casting process inherently has a relatively short life due, in part, to the critical surface details required for the metallic housing.

Also, the surface finish of the die-cast housing is difficult to control, and normally necessitates secondary machining operations on the die-cast housing. Furthermore, with a die-cast housing, pins are attached to the casting to provide mounting details and bearing surfaces for the gears. The housing functions as an oil pan with lubricating oil for the gears. The interface between the casting and pins defines a joint or discontinuous surface for potential oil leakage from the housing.

Accordingly, a primary objective of the present invention is the provision of an improved transmission housing.

A further objective of the present invention is the provision of a composite transmission housing having a metal base and a plastic oil pan.

Another objective of the present invention is the provision of a composite transmission housing wherein a plastic body is over-molded onto a die-cast metallic skeleton.

Still another objective of the present invention is the provision of a composite transmission housing having a metal component for mechanical strength and an over-molded plastic component to form a leak-free oil pan.

Yet another objective of the present invention is the provision of a method of manufacturing a composite transmission housing.

Another objective of the present invention is the provision of a composite transmission housing which is economical to manufacture and durable in use.

These and other objectives will become apparent from the following description of the invention.

### SUMMARY OF THE INVENTION

The composite transmission housing of the present invention includes a die-cast metal base with an over-molded plastic body. The metal base provides mechanical strength for supporting the plurality of gears in the housing, while the plastic body forms an oil pan with a continuous interior surface which is free from joints so as to minimize or eliminate oil leakage from the housing. Gear pins are internally formed in the housing, which eliminate separate gear pins.

In the method of manufacturing the composition transmission housing according to the present invention, the metal skeletal base is cast and then inserted into an injection mold, and the plastic body is over-molded onto the metal base. The over-molding step provides a continuous interior surface on the plastic body which is free from joints.

### BRIEF DESCRIPTION OF THE DRAWINGS

FIG. 1 is a sectional view of a washing machine showing a transmission housing therein.

FIG. 2 is a perspective view of the die-cast metal base or skeleton.

FIG. 3 is a sectional view of a conventional die-cast prior art transmission housing.

FIG. 4 is a sectional view of the composite transmission housing of the present invention.

### DETAILED DESCRIPTION OF THE PREFERRED EMBODIMENT

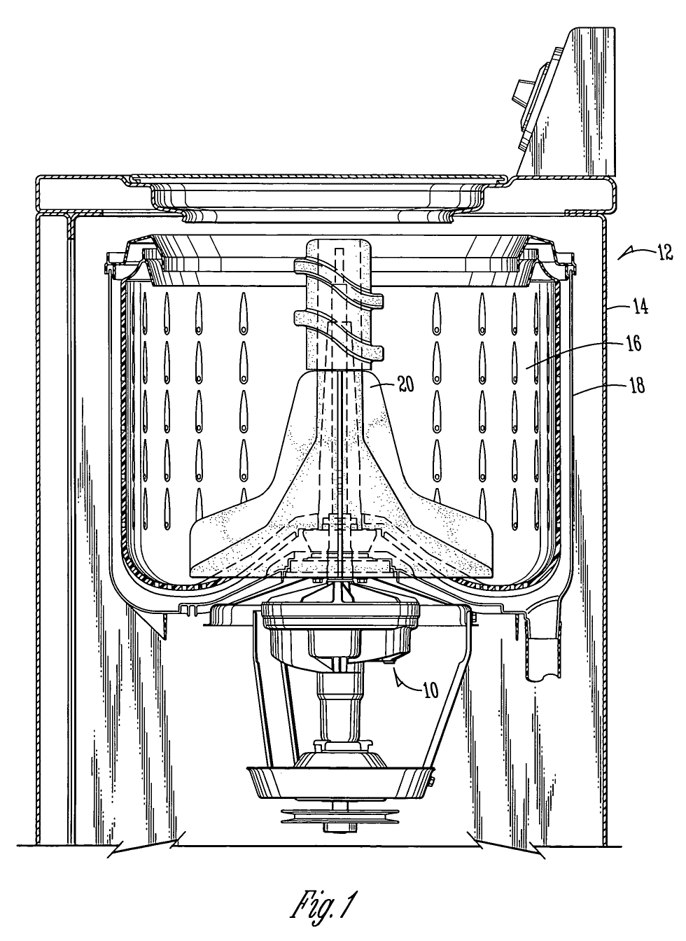

With reference to the drawings, the reference numeral 10 generally designates a transmission housing. In FIG. 1, the transmission housing 10 is shown in use on a washing machine 12 having a cabinet 14, a rotatable, perforated tub 16 mounted within a liner 18, and an agitator 20. The transmission housing 10 includes a plurality of gears (not shown) which are driven by a motor (not shown) so as to oscillate the agitator 20 and rotate the tub 16 at certain times during the washing operation of the machine 12.

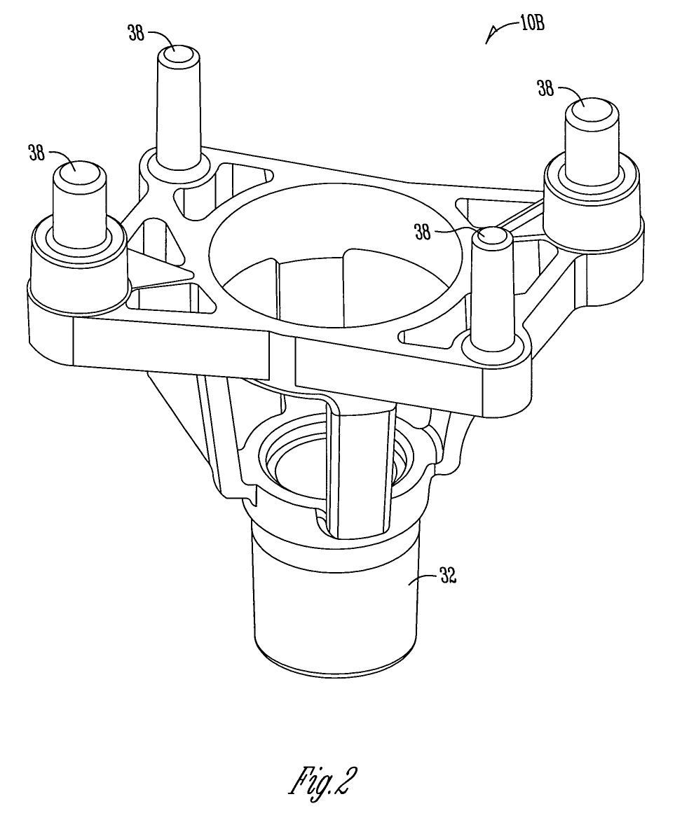

A conventional transmission housing 10A is shown in FIG. 2. The conventional housing 10A includes a base 22 formed entirely of die-cast metal. The metal base 22 provides the mechanical strength to support gear pins 24, and also forms an oil pan 26 for the transmission oil. The gear pins 24 extend through holes 28 formed in the base 22. The holes 28 form a discontinuous inner surface 30 for the base 22, such that the juncture or interface between the holes 28 and the gear pins 24 create a potential for oil leakage.

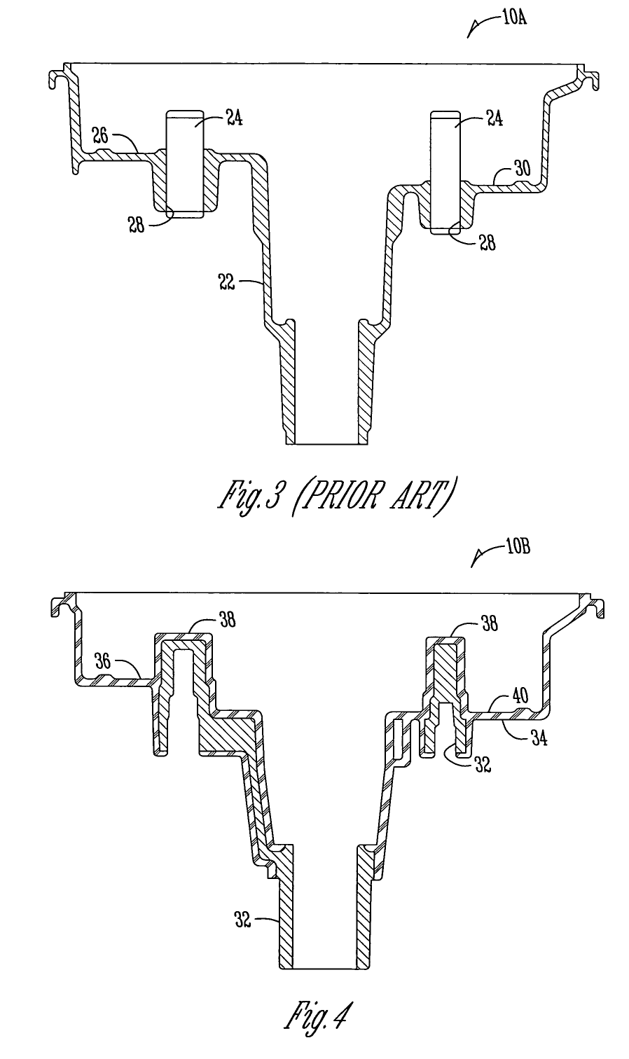

The composite transmission housing 10B of the present invention is shown in FIG. 3. The housing 10B includes a die-cast metal base or skeleton 32 with a plastic over-molded body 34. The metal base 32 forms the lower portion of the housing 10B, while the plastic body 34 forms the upper portion of the housing 10B. The metallic base 32 provides mechanical strength for the transmission gears (not shown), while the plastic body 34 forms an oil pan 36 for the housing 10B. Additionally, the mechanical strength of the base 32 is important for resisting the torsional force of the brake (not shown) that is applied to the lower stem region 42. The brake resists the reaction torque that is caused by the oscillation of agitator 20 during the wash cycle.

The composite housing 10B has gear pins 38 formed therein, such that the interior surface 40 of the plastic body 34 is continuous and free from holes or joints. Therefore, the risk of oil leakage, as in the housing 10A, is eliminated.

The method of manufacturing the composite transmission housing of the present invention includes the steps of (1) die-casting the metal base 32; (2) inserting the metal base 32 into an injection mold (not shown); and (3) over-molding the plastic body 34 onto the metal base 32.

The die-cast metal base 32 of the present invention is smaller and has less details than the die-cast metal base 22 of the prior art. By creating a smaller die-cast base with less critical surface details, the life of the die-cast tooling is extended in the process of the present invention. Also, since the finish of the interior surface 40 of the plastic body 34 is easier to control than the finish of the interior surface 30 of the die-cast base 22, the housing 10B of the present invention requires greatly reduced secondary machining operations as compared to the die-cast base 22 of the prior art housing 10A. Manufacturing costs in the composite housing 10B are further reduced by eliminating the gear pins 24 which are in the prior art housing 10A.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A composite transmission housing, comprising:
a die-cast metal base; and
a plastic body over-molded on the metal base.

2. The composite transmission housing of claim 1 further comprising upper and lower ends, the upper end being formed by the plastic body and the lower end being formed by the metal base.

3. The composite transmission housing of claim 1 wherein the plastic body forms an oil pan.

4. A composite transmission housing, comprising:
a metal base for mechanical strength to support a plurality of transmission gears; and
a plastic oil pan over-molded onto the metal base.

5. The composite transmission housing of claim 4 wherein the oil pan defines an upper portion of the housing and the base defines a lower end of the housing.

6. A method of manufacturing a composite transmission housing, comprising:
die-casting a metal base;
inserting the metal base into an injection mold;
over-molding a plastic body onto the metal base.

7. The method of claim 6 wherein the plastic body forms an oil pan.

8. The method of claim 6 wherein the plastic body is over-molded to form an upper portion of the housing.
